(19) United States
(12) Patent Application Publication
(10) Pub. No.: US 2022/0386183 A1
(43) Pub. Date: Dec. 1, 2022

(54) METHOD AND APPARATUS FOR CALL SETUP

(71) Applicant: Telefonaktiebolaget LM Ericsson (publ), Stockholm (SE)

(72) Inventors: Liangliang Guo, Shanghai (CN); Chunmiao Liu, Shanghai (CN); Liang Shi, Shanghai (CN)

(21) Appl. No.: 17/772,402

(22) PCT Filed: Oct. 23, 2020
(86) PCT No.: PCT/EP2020/079887

§ 371 Date: Apr. 27, 2022

(30) Foreign Application Priority Data
Oct. 30, 2019 (CN) PCT/CN2019/114439

(51) Int. Cl. H04W 36/00

(52) U.S. Cl. CPC H04W 36/0022; H04L 65/1016

(57) ABSTRACT

Various embodiments of the present disclosure provide a method for call setup. The method which may be performed by a session management node comprises receiving an evolved packet system (EPS) fallback indicator from a mobility management node. In an embodiment, the EPS fallback indicator may indicate that a fallback to an EPS for an Internet protocol multimedia subsystem (IMS) voice service is ongoing. The method further comprises reporting an EPS fallback event to a policy charging node, according to the EPS fallback indicator.

### FIELD OF THE INVENTION

The present disclosure generally relates to communication networks, and more specifically, to a method and apparatus for call setup.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. With the rapid development of networking and communication technologies, wireless communication networks such as long-term evolution (LTE)/fourth generation (4G) network and new radio (NR)/fifth generation (5G) network are expected to achieve high traffic capacity and end-user data rate with lower latency. To meet the diverse requirements of new services across a wide variety of industries, the 3rd generation partnership project (3GPP) is developing various network function services for the 5G system (5GS) architecture and the policy and charging control framework. This enables flexible network deployment and operation, by distributed or centralized deployment and the independent scaling between control plane (CP) and user plane (UP) functions.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In a communication system such as 5GS, a terminal device such as user equipment (UE) camped on a next generation-radio access network (NG-RAN) may have one or more ongoing packet data unit (PDU) sessions each including one or more quality of service (QoS) flows. For example, a serving public land mobile network (PLMN) access and mobility management function (AMF) may send an indication towards the UE during the registration procedure that Internet protocol multimedia subsystem (IMS) voice over packet switched (PS) session is supported, and the UE can be registered in the IMS. The NG-RAN may be configured to support evolved packet system (EPS) fallback for IMS voice and decide to trigger fallback to EPS, considering the UE's capabilities, the indication from the AMF that “Redirection for EPS fallback for voice is possible”, the network configuration and radio conditions, etc. For the EPS fallback for IMS voice, a packet gateway control plane function (PGW-C) combined with a session management function (SMF) can be informed when the EPS fallback is triggered by the NG-RAN, and the NG-RAN may initiate either handover (HO) or access network (AN) release via inter-system redirection to the EPS. During the HO or redirection to the EPS, the session initiation protocol (SIP) signaling exchange between the UE and the IMS network may be still ongoing, but the default QoS flow/default bearer for IMS signaling transferred may not be available for a short period of time. This may result in loss of SIP signaling and call setup latency. Therefore, it may be desirable to improve call setup in case of EPS fallback.

Various embodiments of the present disclosure propose a solution for optimization of call setup, which can avoid call setup signaling (e.g., SIP signaling) loss in EPS fallback, for example, by notifying an EPS fallback event to an IMS in an efficient manner, so as to ensure the successful call setup in EPS fallback, without significant impact on call setup time for voice over new radio (VoNR).

According to a first aspect of the present disclosure, there is provided a method which may be performed by a session management node such as a PGW-SMF. The method comprises receiving an EPS fallback indicator from a mobility management node. The EPS fallback indicator may indicate that a fallback to an EPS for an IMS voice service is ongoing. In accordance with an exemplary embodiment, the method further comprises reporting an EPS fallback event to a policy charging node, according to the EPS fallback indicator.

In accordance with some exemplary embodiments, the EPS fallback event may be reported to the policy charging node, in response to a subscription of the EPS fallback event by the policy charging node.

In accordance with some exemplary embodiments, the subscription of the EPS fallback event by the policy charging node may be informed to the session management node in a first notification from the policy charging node.

In accordance with some exemplary embodiments, the EPS fallback event may be reported to the policy charging node in a second notification from the session management node.

According to a second aspect of the present disclosure, there is provided an apparatus which may be implemented as a session management node. The apparatus may comprise one or more processors and one or more memories storing computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus which may be implemented as a session management node. The apparatus comprises a receiving unit and a reporting unit. In accordance with some exemplary embodiments, the receiving unit may be operable to carry out at least the receiving step of the method according to the first aspect of the present disclosure. The reporting unit may be operable to carry out at least the reporting step of the method according to the first aspect of the present disclosure.

According to a fifth aspect of the present disclosure, there is provided a method which may be performed by a policy charging node. The method comprises receiving an EPS fallback event report from a session management node. The method further comprises reporting an EPS fallback event to a call control node, according to the EPS fallback event report.

In accordance with some exemplary embodiments, the EPS fallback event may be reported to the call control node, in response to a subscription of the EPS fallback event by the call control node.

In accordance with some exemplary embodiments, the subscription of the EPS fallback event by the call control node may be informed to the policy charging node in an authentication and authorization request from the call control node.

In accordance with some exemplary embodiments, the EPS fallback event may be reported to the call control node in a re-authentication request from the policy charging node.

According to a sixth aspect of the present disclosure, there is provided an apparatus which may be implemented as a policy charging node. The apparatus comprises one or more processors and one or more memories storing computer program codes. The one or more memories and the computer program codes may be configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus which may be implemented as a policy charging node. The apparatus comprises a receiving unit and a reporting unit. In accordance with some exemplary embodiments, the receiving unit may be operable to carry out at least the receiving step of the method according to the fifth aspect of the present disclosure. The reporting unit may be operable to carry out at least the reporting step of the method according to the fifth aspect of the present disclosure.

According to a ninth aspect of the present disclosure, there is provided a method which may be performed by a call control node. The method comprises receiving an EPS fallback event report from a policy charging node. The method further comprises handling signaling based at least in part on the EPS fallback event report.

In accordance with some exemplary embodiments, the EPS fallback event report may be received from the policy charging node, in response to a subscription of an EPS fallback event by the call control node.

In accordance with some exemplary embodiments, the subscription of the EPS fallback event by the call control node may be informed to the policy charging node in an authentication and authorization request from the call control node.

In accordance with some exemplary embodiments, the EPS fallback event report may be received in a re-authentication request from the policy charging node.

In accordance with some exemplary embodiments, the handling of the signaling may comprise at least one of: buffering call setup signaling, prolonging transmission time of call setup signaling, and holding one or more SIP signals.

In accordance with some exemplary embodiments, the method according to the ninth aspect of the present disclosure may further comprise: resuming a call setup in response to an access type change event.

In accordance with some exemplary embodiments, the access type change event may comprise at least one of: a radio access technology (RAT) type change event, and an Internet protocol connectivity access network (IP CAN) change event.

According to a tenth aspect of the present disclosure, there is provided an apparatus which may be implemented as a call control node. The apparatus comprises one or more processors and one or more memories storing computer program codes. The one or more memories and the computer program codes may be configured to, with the one or more processors, cause the apparatus at least to perform any step of the method according to the ninth aspect of the present disclosure.

According to an eleventh aspect of the present disclosure, there is provided a computer-readable medium having computer program codes embodied thereon which, when executed on a computer, cause the computer to perform any step of the method according to the ninth aspect of the present disclosure.

According to a twelfth aspect of the present disclosure, there is provided an apparatus which may be implemented as a call control node. The apparatus comprises a receiving unit and a handling unit. In accordance with some exemplary embodiments, the receiving unit may be operable to carry out at least the receiving step of the method according to the ninth aspect of the present disclosure. The handling unit may be operable to carry out at least the handling step of the method according to the ninth aspect of the present disclosure.

The proposed solution according to some exemplary embodiments can enable EPS fallback to be identified by the IMS in early time, so that a procedure of call setup can be optimized with reduced latency and enhanced resource efficiency. On the other hand, some exemplary embodiments may support adaptive handling of SIP signaling to ensure the successful call setup in EPS fallback, without affecting other services such as VoNR.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1 is a diagram illustrating an example of EPS fallback for IMS voice according to an embodiment of the present disclosure;

FIG. 2 is a diagram illustrating an example of retransmission during EPC fallback according to an embodiment of the present disclosure;

FIG. 3 is a diagram illustrating an example of EPS fallback subscription and report according to an embodiment of the present disclosure;

FIG. 4 is a diagram illustrating an example of SIP message handling according to an embodiment of the present disclosure;

FIG. 5 is a flowchart illustrating a method according to some embodiments of the present disclosure;

FIG. 6 is a flowchart illustrating another method according to some embodiments of the present disclosure;

FIG. 7 is a flowchart illustrating yet another method according to some embodiments of the present disclosure;

FIG. 8 is a block diagram illustrating an apparatus according to some embodiments of the present disclosure;

FIG. 9 is a block diagram illustrating another apparatus according to some embodiments of the present disclosure;

FIG. 10 is a block diagram illustrating yet another apparatus according to some embodiments of the present disclosure; and

FIG. 11 is a block diagram illustrating a further apparatus according to some embodiments of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

As used herein, a network “node” can be implemented either as a network element on a dedicated hardware, as a software instance running on a dedicated hardware, or as a virtualized function instantiated on an appropriate platform, e.g. on a cloud infrastructure.

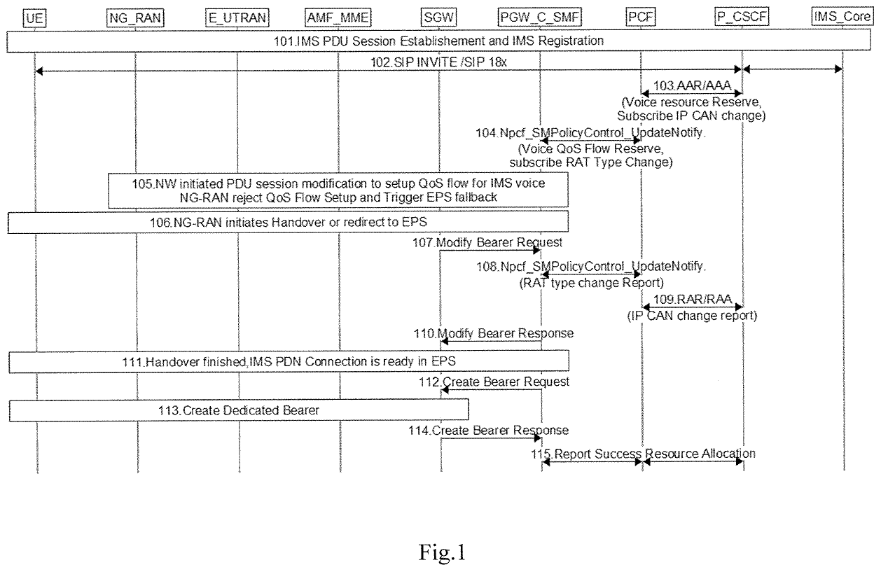

FIG. 1 is a diagram illustrating an example of EPS fallback for IMS voice according to an embodiment of the present disclosure. Some exemplary network elements such as a UE, a NG-RAN, an evolved universal terrestrial radio access network (E-UTRAN), an access and mobility management function and a mobility management entity (AMF-MME), a serving gateway (SGW), a PGW-C-SMF (also called PGW-C+SMF or PGW-SMF in some embodiments), a policy charging function (PCF), a proxy call serving call control function (P-CSCF) and an IMS-Core are depicted in FIG. 1. According to the embodiment shown in FIG. 1, the IMS PDU session establishment in a 5GS and the IMS registration can be implemented for the UE in step 101. Then in step 102, a SIP call may be initiated in the 5GS and the P-CSCF may receive SIP signaling for call setup, for example, by “SIP INVITE/SIP 18×”. In step 103, the P-CSCF may request voice resource reservation in the 5GS and subscribe “Internet protocol connectivity access network (IP CAN) change” to the PCF, for example, by signaling messages such as authentication and authorization request/authentication and authorization answer (AAR/AAA). In step 104, the PCF may request voice resource reservation (e.g., voice QoS flow reservation) in the 5GS and subscribe “radio access technology (RAT) type change” to the PGW-C-SMF, for example, by a signaling message such as Npcf_SMPolicyControl_UpdateNotify. In step 105, the PGW-C-SMF may initiate the voice QoS flow setup. For example, the network (NW) may initiate a PDU session modification to set up QoS flow for IMS voice. The NG-RAN may reject the QoS flow setup and trigger EPS fallback. Correspondingly, the PGW-C-SMF may be informed the rejection by the NG-RAN due to IMS voice EPS fallback.

In step 106, the NG-RAN may initiate the handover or redirect to the EPS. Then the SGW may send a modify bearer request to the PGW-C-SMF in step 107. After an IMS packet data network (PDN) connection is established in the EPS, the PGW-C-SMF may report the RAT type change to the PCF in step 108, for example, by a signaling message such as Npcf_SMPolicyControl_UpdateNotify. In step 109, the PCF may report the IP CAN change to the P-CSCF, for example, by signaling messages such as re-authentication request/re-authentication answer (RAR/RAA). At this point, the P-CSCF can know the EPS fallback taken place. In step 110, the PGW-C-SMF may send a modify bearer response to the SGW. After the handover is finished in step 111, the IMS PDN connection is ready in the EPS. In step 112, the PGW-C-SMF may send a create bearer request to the SGW. In the case that the dedicated beater is created in step 113, the SGW may send a create bearer response to the PGW-C-SMF in step 114. Correspondingly, the PGW-C-SMF may report the success resource allocation to the PCF in step 115 and then to the P-CSCF.

Although the SIP signaling exchange between the UE and the IMS network may be still ongoing during the handover or redirection to the EPS, the default QoS flow or the default bearer for IMS signaling may be unavailable for a certain period of time. There may be some options to avoid SIP signaling loss in EPS fallback. For example, in an option, the 5GS and RANs may need to support forwarding tunnel (either direct or indirect tunnel), but this option may not be supported by most products in initial commercia deployment, e.g. due to its complexity. Alternatively, signaling caching and delayed transmission may be used in an IMS/P-CSCF and a UE. As the IMS/P-CSCF cannot distinguish EPS fallback and VoNR, the signaling caching and delayed transmission scheme may be used for the VoNR. In case of one IMS network supporting both VoNR and EPS fallback, this alternative option may prolong the setup time for the VoNR. There is no solution in 3GPP to inform the P-CSCF of the EPS fallback early to avoid the impact on the VoNR.

There are many problems in the existing solutions. For example, due to complexity, the forwarding tunnel may not be supported by some 5GC and RAN products in the customer trial test and initial commercial launch. Even signaling (e.g., session initiation protocol/transmission control protocol (SIP/TCP) signaling) retransmission is used, the call setup may be still failed due to SIP signaling loss. On other hand, setting the forwarding tunnel in the 5GC or RAN may prolong the HO duration and eventually prolong the call setup time. Moreover, the SIP signaling caching and delayed transmission between an IMS P-CSCF and a UE may impact the VoNR call setup time, in case of one IMS network serving both VoNR and EPS fallback. The signaling bearer may be temporarily unavailable during EPC fallback. But for VoLTE and VoNR, the signaling bearer may be always available. For the P-CSCF, it may be a dilemma. For example, if the P-CSCF continues with SIP signaling, in case of EPC fallback, it may result in SIP retransmission (UDP) or TCP retransmission (TCP), the retransmission interval increases exponentially. This prolongs the call setup. If the P-CSCF holds the SIP signaling for some time, it can reduce call setup time in case of EPC fallback. But for VoLTE and VoNR, this is totally not necessary and it may prolong the call setup.

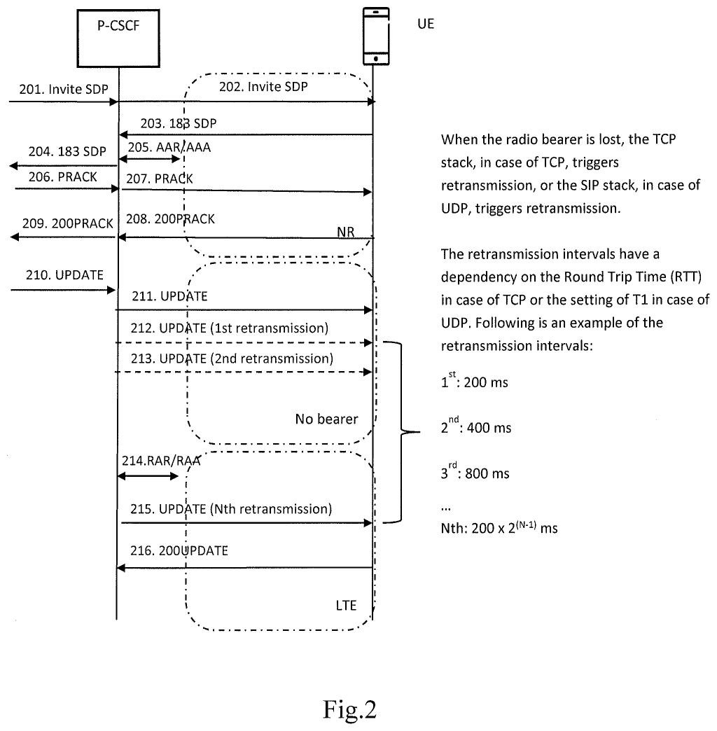

FIG. 2 is a diagram illustrating an example of retransmission during EPC fallback according to an embodiment of the present disclosure. For simplicity, FIG. 2 only depicts exemplary elements such as a UE and a P-CSCF in a communication system. In practice, the communication system may further include any additional elements suitable to support communication between wireless devices or between a wireless device and another communication device, such as a landline telephone, a service provider, or any other network node or terminal device. The communication system may provide communication and various types of services to one or more wireless devices to facilitate the wireless devices' access to and/or use of the services provided by, or via, the communication system.

The initial part of an IMS INVITE (call session) setup procedure is schematically described with respect to steps 201-216. As shown in FIG. 2, the calling party may initiate 201 an INVITE session (call) to the called party (i.e., the originating UE). The P-CSCF may forward 202 the INVITE to the UE. The UE may reply 203 with “183 session description protocol (SDP)” which may be forwarded 204 to the calling party by the P-CSCF. In this example, the P-CSCF may send 205 an AAR to request the dedicated bearer for IMS media (e.g., as describe in connection with step 103 of FIG. 1). This may trigger EPS fallback as described with respect to FIG. 1. According to the procedure shown in FIG. 2, some signaling exchange may occur between the calling party and the called party through the P-CSCF, for example, by signaling messages such as “PRACK” and “200PRACK” in steps 206-209. The EPS fallback may not be initiated till step 209, and the default bearer for the IMS signaling in the 5G/NR network may be still available. Thus, there may be still chances for some subsequent signaling to flow between two parties.

In the example illustrated in FIG. 2, the radio communication may be falling back from the 5G/NR network to the 4G/LTE network, and no default bearer is available. The P-CSCF may not be aware of that the EPS fallback is triggered. In this case, the P-CSCF may receive 210 a SIP UPDATE message and forward 211 the SIP UPDATE message to the UE which may not have any default bearer. It can be realized that the SIP UPDATE message may be retransmitted 212-213 to the UE as no default bearer is available. The retransmission of the SIP message may happen from the P-CSCF to the UE if the UPDATE message is not able to reach the UE. In case of the user datagram protocol (UDP), the retransmission time may be one second, which is more than the EPS fallback time. Thus, the retransmission may add up the call setup time. Only when an IP CAN change notification is received 214 by the P-CSCF (e.g., as describe in connection with step 109 of FIG. 1), by comparing the “Netloc” received in the user provided “PANI” in the INVITE and the received RAT type, the P-CSCF can know this is the EPS fallback. Then, the retransmission 215 of the UPDATE message can reach the UE. In a response, the UE may send 216 back “200 UPDATE” to indicate the receipt of the UPDATE message.

In order to enhance the transmission efficiency and improve the network performance, various embodiments of the present disclosure propose a solution to solve SIP signaling loss in EPS fallback. According to the proposed solution, a 5GC EPS fallback event may be notified to specific network elements (e.g., a policy node such as PCF, an IMS node such as P-CSCF, a combined functional node such as PGW+SMF, etc.) to optimize call setup such as IMS call setup, for example, by reducing call setup time for the 5GC EPC fallback event. In accordance with an exemplary embodiment, the PGW+SMF can immediately report the EPS fallback event to the PCF after receiving an EPS fallback indicator from a NG-RAN, and the PCF can report this EPS fallback event to the IMS (e.g., to the P-CSCF). As such, the IMS can know the EPS fallback early, and handle SIP signaling in an enhanced way, e.g., buffer signaling or prolong the retransmission time until the PDN connection and default bearer is ready in the EPS (e.g., when a RAT type change is received by the P-CSCF).

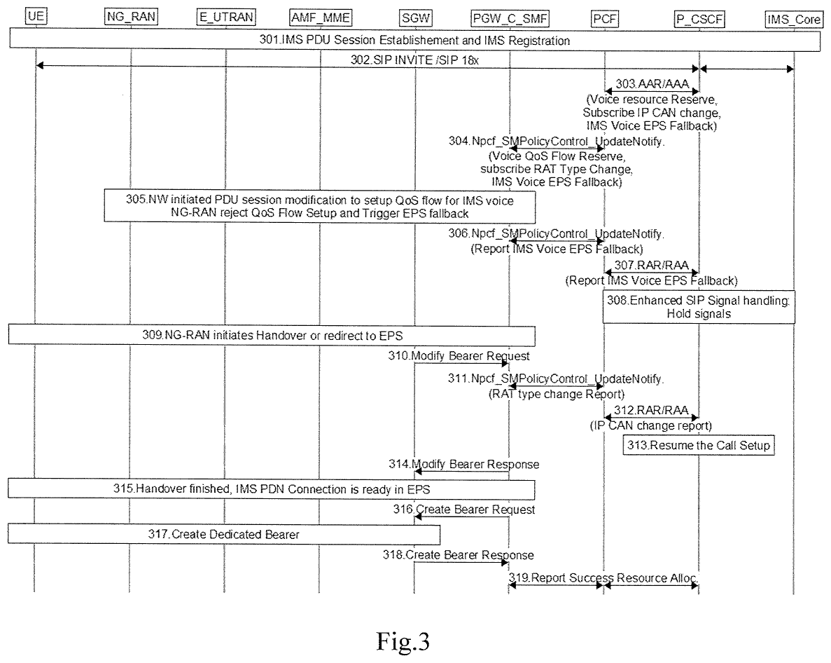

FIG. 3 is a diagram illustrating an example of EPS fallback subscription and report according to an embodiment of the present disclosure. Similar to FIG. 1, some exemplary network elements such as a UE, a NG-RAN, an E-UTRAN, an AMF-MME, a SGW, a PGW-C-SMF, a PCF, a P-CSCF and an IMS-Core are depicted in FIG. 3. Different from the procedure shown in FIG. 1, the procedure shown in FIG. 3 introduces new event subscription and report over an interface (e.g., N7) between the PGW-C-SMF and the PCF and over an interface (e.g., N5/Rx) between the PCF and the P-CSCF. It can be appreciated that although only Rx case is illustrated in FIG. 3, the proposed solution may also be applicable for N5 case or other possible cases.

According to the procedure shown in FIG. 3, the IMS PDU session establishment in the 5GS and the IMS registration can be implemented for the UE in step 301. Then in step 302, a SIP call may be initiated in the 5GS and the P-CSCF may receive SIP signaling for call setup, for example, by “SIP INVITE/SIP 18×”. In step 303, the P-CSCF may request voice resource reservation in the 5GS and subscribe “IP CAN change” and “IMS voice EPS Fallback” to the PCF, for example, by signaling messages such as AAR/AAA. In step 304, the PCF may request voice resource reservation (e.g., voice QoS flow reservation) in the 5GS and subscribe “RAT Type change” and “IMS voice EPS Fallback” to the PGW-C-SMF, for example, by a signaling message such as Npcf_SMPolicyControl_UpdateNotify. In step 305, the PGW-C-SMF may initiate the voice QoS flow setup. For example, the NW may initiate a PDU session modification to set up QoS flow for IMS voice. The NG-RAN may reject the QoS flow setup and trigger EPS fallback. Correspondingly, the PGW-C-SMF may be informed the rejection by the NG-RAN due to IMS voice EPS fallback.

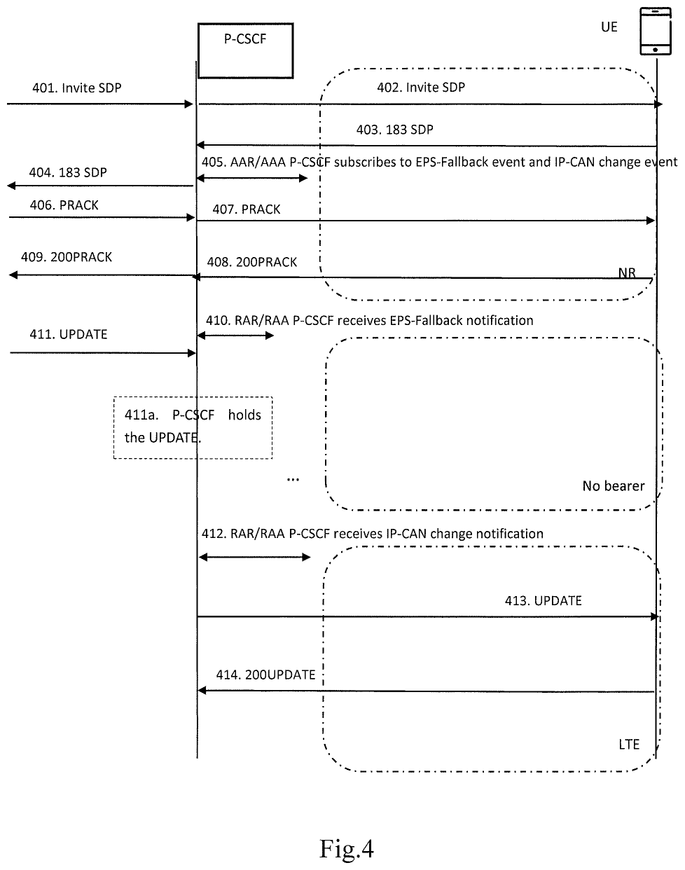

In accordance with an exemplary embodiment, the PGW-C-SMF may report “IMS Voice EPS Fallback” to the PCF in step 306, for example, by a signaling message such as Npcf_SMPolicyControl_UpdateNotify. Then the PCF may report “IMS Voice EPS Fallback” to the P-CSCF in step 307, for example, by signaling messages such as RAR/RAA. At this point, the P-CSCF can know the EPS fallback taken place. In step 308, the P-CSCF may handle SIP signaling in an optimized way, for example, as described with respect to FIG. 4.

According to the procedure shown in FIG. 3, the NG-RAN may initiate the handover or redirect to the EPS in step 309, and the SGW may send a modify bearer request to the PGW-C-SMF in step 310. After an IMS PDN connection is established in the EPS, the PGW-C-SMF may report the RAT type change to the PCF in step 311, for example, by a signaling message such as Npcf_SMPolicyControl_UpdateNotify. In step 312, the PCF may report the IP CAN change to the P-CSCF, for example, by signaling messages such as RAR/RAA. The IP CAN change report received by the P-CSCF may indicate that the EPS fallback with the default bearer is successful. After receiving the IP CAN change report, the P-CSCF may handle the SIP signaling in a normal way (e.g., as described with respect to FIG. 1), and resume or continue the call setup in step 313.

Similar to the procedure as shown in FIG. 1, the PGW-C-SMF in FIG. 3 may send a modify bearer response to the SGW in step 314. After the handover is finished in step 315, the IMS PDN connection is ready in the EPS. In step 316, the PGW-C-SMF may send a create bearer request to the SGW. In the case that the dedicated beater is created in step 317, the SGW may send a create bearer response to the PGW-C-SMF in step 318. Correspondingly, the PGW-C-SMF may report the success resource allocation to the PCF in step 319 and then to the P-CSCF.

FIG. 4 is a diagram illustrating an example of SIP message handling according to an embodiment of the present disclosure. Similar to FIG. 2, FIG. 4 depicts exemplary elements such as a UE and a P-CSCF in a communication system. Different from the procedure shown in FIG. 2, the procedure shown in FIG. 4 introduces some enhanced SIP signaling handling in the P-CSCF. It can be appreciated that although it is described with respect to FIG. 4 how the P-CSCF can handle SIP messages based on Rx event reports for the IMS call EPS fallback, the proposed solution may also be applicable for the N5 case or other possible cases.

Similar to FIG. 2, the initial part of the IMS INVITE (call session) setup procedure is schematically described with respect to steps 401-414. As shown FIG. 4, the calling party may initiate 401 an INVITE session (call) to the called party (i.e., the originating UE). The P-CSCF may forward 402 the INVITE to the UE. The UE may reply 403 with “183 SDP” which may be forwarded 404 to the calling party by the P-CSCF. In this example, the P-CSCF may send 405 an AAR to request the dedicated bearer for IMS media (e.g., as described in connection with step 303 of FIG. 3). In accordance with an exemplary embodiment, the EPS fallback event and/or IP-CAN change event may be subscribed, and the AAR may trigger the EPS fallback, as described with respect to FIG. 3.

According to the procedure shown in FIG. 4, some signaling exchange may occur between the calling party and the called party through the P-CSCF, for example, by signaling messages such as “PRACK” and “200PRACK” in steps 406-409. The fallback may not be initiated till step 409, and the default bearer for the IMS signaling in the 5G/NR network may be still available. Thus, there may be still chances for some subsequent signaling to flow between two parties.

In the example illustrated in FIG. 4, the P-CSCF may receive 410 an EPS fallback notification (e.g., as indicated by step 307 in FIG. 3). This may be an indication that the EPS fallback is about to start. According to an embodiment, the radio communication may be falling back from the 5G/NR network to the 4G/LTE network, and no default bearer is available. The P-CSCF may receive 411 a SIP UPDATE message and hold 411a this signaling message to the UE which may not have any default bearer. Thus, the retransmission of the SIP message can be avoided from the calling party. This can reduce the session setup latency. In this case, the held signaling message such as the SIP UPDATE message is to be forwarded. It can be realized that the signaling message to be forwarded can be any other signaling message, depending on the call flows and network latency situation. In response to receipt 412 of an IP-CAN change notification (e.g., as described in connection with step 312 of FIG. 3), the P-CSCF can know the default bearer is available. The P-CSCF may send 413 the buffered UPDATE message to the called UE. In a response, the UE may send 414 back “200 UPDATE” to indicate the receipt of the UPDATE message.

It can be appreciated that signaling messages and network elements shown in FIGS. 1-4 are just examples, and more or less alternative signaling messages and network elements may be involved in the call setup according to exemplary embodiments of the present disclosure.

It is noted that some embodiments of the present disclosure are mainly described in relation to 5G or NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

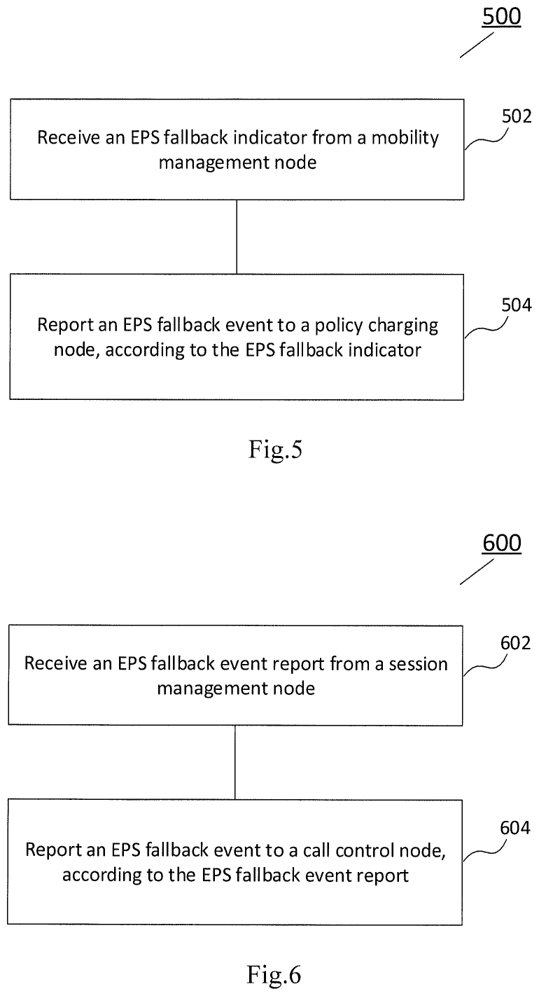

FIG. 5 is a flowchart illustrating a method 500 according to some embodiments of the present disclosure. The method 500 illustrated in FIG. 5 may be performed by a session management node or an apparatus communicatively coupled to the session management node. In accordance with an exemplary embodiment, the session management node may comprise a PGW-SMF, PGW+SMF, a PGW-C-SMF (such as the PGW-C-SMF shown in FIG. 3) or any other suitable network entity or instance which can act as a packet gateway supporting a session management function.

According to the exemplary method 500 illustrated in FIG. 5, the session management node may receive an EPS fallback indicator from a mobility management node (e.g., the AMF-MME shown in FIG. 3), as shown in block 502. In accordance with an exemplary embodiment, the EPS fallback indicator may indicate that a fallback to an EPS for an IMS voice service is ongoing. According to the EPS fallback indicator, the session management node may report an EPS fallback event to a policy charging node (e.g., the PCF shown in FIG. 3), as shown in block 504.

In accordance with some exemplary embodiments, the EPS fallback event may be reported to the policy charging node, in response to a subscription of the EPS fallback event by the policy charging node. Optionally, the subscription of the EPS fallback event by the policy charging node may be informed to the session management node in a first notification (e.g., “Npcf_SMPolicyControl_UpdateNotify” shown in step 304 of FIG. 3) from the policy charging node.

In an exemplary embodiment, the EPS fallback event may be reported to the policy charging node in a second notification (e.g., “Npcf_SMPolicyControl_UpdateNotify” shown in step 306 of FIG. 3) from the session management node.

FIG. 6 is a flowchart illustrating a method 600 according to some embodiments of the present disclosure. The method 600 illustrated in FIG. 6 may be performed by a policy charging node or an apparatus communicatively coupled to the policy charging node. In accordance with an exemplary embodiment, the policy charging node may comprise a PCF (such as the PCF shown in FIG. 3), or any other suitable network entity or instance which can support a policy charging function.

According to the exemplary method 600 illustrated in FIG. 6, the policy charging node may receive an EPS fallback event report from a session management node (e.g., the session management node as described with respect to FIG. 5), as shown in block 602. According to the EPS fallback event report, the policy charging node may report an EPS fallback event to a call control node (e.g., the P-CSCF shown in FIG. 3 and FIG. 4), as shown in block 604. In an exemplary embodiment, the EPS fallback event may be reported to the call control node in a re-authentication request (e.g., the RAR shown in step 307 of FIG. 3) from the policy charging node.

In accordance with some exemplary embodiments, the EPS fallback event may be reported to the call control node, in response to a subscription of the EPS fallback event by the call control node. Optionally, the subscription of the EPS fallback event by the call control node may be informed to the policy charging node in an authentication and authorization request (e.g., the AAR shown in step 303 of FIG. 3) from the call control node.

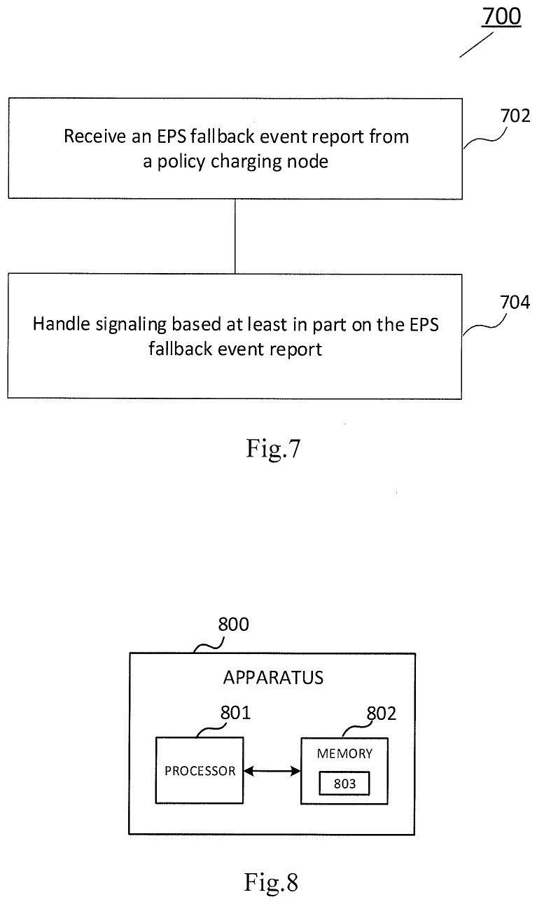

FIG. 7 is a flowchart illustrating a method 700 according to some embodiments of the present disclosure. The method 700 illustrated in FIG. 7 may be performed by a call control node or an apparatus communicatively coupled to the call control node. In accordance with an exemplary embodiment, the call control node may comprise a P-CSCF (such as the P-CSCF shown in FIG. 3 and FIG. 4), or any other suitable network entity or instance which can support a proxy-call serving call control function and/or a proxy-call session control function.

According to the exemplary method 700 illustrated in FIG. 7, the call control node may receive an EPS fallback event report from a policy charging node (e.g., the policy charging node as described with respect to FIG. 6), as shown in block 702. In accordance with some exemplary embodiments, the EPS fallback event report may be received in a re-authentication request (e.g., the RAR shown in step 307 of FIG. 3) from the policy charging node. The call control node can handle signaling based at least in part on the EPS fallback event report, as shown in block 704. In accordance with some exemplary embodiments, the handling of the signaling may comprise at least one of: buffering call setup signaling (e.g., a SIP UPDATE message, etc.), prolonging transmission time of call setup signaling (e.g., (re)transmission time of a SIP UPDATE message, etc.), and holding one or more SIP signals. It can be appreciated that the call control node may be able to handle any possible message signaling in any suitable manner, in response to the EPS fallback event report.

In accordance with some exemplary embodiments, the EPS fallback event report may be received from the policy charging node, in response to a subscription of an EPS fallback event by the call control node. Optionally, the subscription of the EPS fallback event by the call control node may be informed to the policy charging node in an authentication and authorization request (e.g., the AAR shown in step 303 of FIG. 3) from the call control node.

In accordance with some exemplary embodiments, the call control node may resume a call setup in response to an access type change event. According to some exemplary embodiments, the access type change event may comprise at least one of: a RAT type change event and an IP CAN change event. Alternatively or additionally, the access type change event may comprise any other suitable event indicating a change of radio communication connectivity.

The proposed solution according to some exemplary embodiments can solve the SIP signaling loss issue in EPS fallback. In an exemplary embodiment, a functional node such as PGW-SMF can immediately report an EPS fallback event to a PCF after receiving an EPS fallback indicator from a NG-RAN, and the PCF can report this EPS fallback event to a P-CSCF for an IMS. Thus, the P-CSCF/IMS can be aware of the EPS fallback timely and handle SIP signaling in a flexible and efficient way, for example, by buffering signaling or prolonging the (re)transmission time until the PDN connection and default bearer is ready in EPS (e.g., in the case that a RAT type change is received by the P-CSCF). Taking advantageous of the proposed solution can avoid the SIP signaling loss and ensure the successful call in EPS fallback. Some embodiments may be applied in early phase of the standalone (SA) 5GS introduction/deployment, for example, as a quick solution for the customer trial test and early commercial deployment. The proposed solution can simplify the network implementation compared to the solution of forwarding tunnel in 5GC and RAN. On the other hand, some embodiments may be realized as a network-based approach to identify EPS fallback, and can avoid or reduce the impact on call setup time for VoNR.

The various blocks shown in FIGS. 5-7 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

FIG. 8 is a block diagram illustrating an apparatus 800 according to various embodiments of the present disclosure. As shown in FIG. 8, the apparatus 800 may comprise one or more processors such as processor 801 and one or more memories such as memory 802 storing computer program codes 803. The memory 802 may be non-transitory machine/processor/computer readable storage medium. In accordance with some exemplary embodiments, the apparatus 800 may be implemented as an integrated circuit chip or module that can be plugged or installed into a session management node as described with respect to FIG. 5, a policy charging node as described with respect to FIG. 6, or a call control node as described with respect to FIG. 7. In such case, the apparatus 800 may be implemented as a session management node as described with respect to FIG. 5, a policy charging node as described with respect to FIG. 6, or a call control node as described with respect to FIG. 7.

In some implementations, the one or more memories 802 and the computer program codes 803 may be configured to, with the one or more processors 801, cause the apparatus 800 at least to perform any operation of the method as described in connection with FIG. 5. In some implementations, the one or more memories 802 and the computer program codes 803 may be configured to, with the one or more processors 801, cause the apparatus 800 at least to perform any operation of the method as described in connection with FIG. 6. In other implementations, the one or more memories 802 and the computer program codes 803 may be configured to, with the one or more processors 801, cause the apparatus 800 at least to perform any operation of the method as described in connection with FIG. 7. Alternatively or additionally, the one or more memories 802 and the computer program codes 803 may be configured to, with the one or more processors 801, cause the apparatus 800 at least to perform more or less operations to implement the proposed methods according to the exemplary embodiments of the present disclosure.

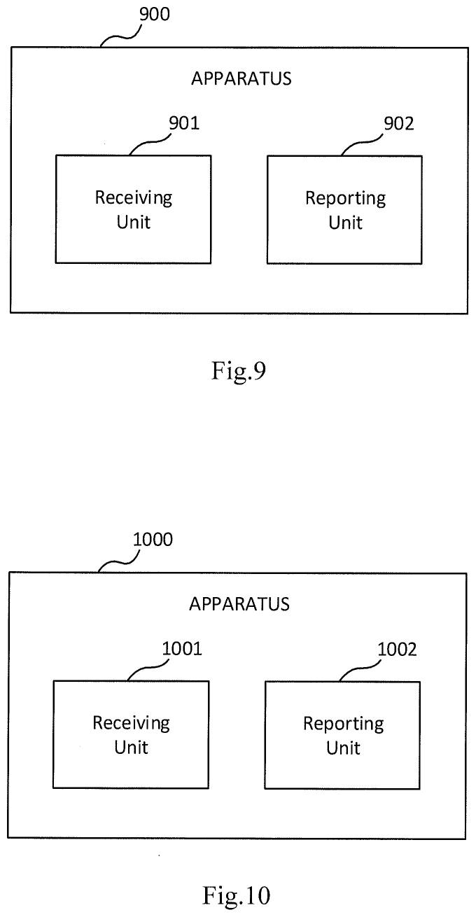

FIG. 9 is a block diagram illustrating an apparatus 900 according to some embodiments of the present disclosure. As shown in FIG. 9, the apparatus 900 may comprise a receiving unit 901 and a reporting unit 902. In an exemplary embodiment, the apparatus 900 may be implemented in a session management node such as the PGW-SMF shown in FIG. 3. The receiving unit 901 may be operable to carry out the operation in block 502, and the reporting unit 902 may be operable to carry out the operation in block 504. Optionally, the receiving unit 901 and/or the reporting unit 902 may be operable to carry out more or less operations to implement the proposed methods according to the exemplary embodiments of the present disclosure.

FIG. 10 is a block diagram illustrating an apparatus 1000 according to some embodiments of the present disclosure. As shown in FIG. 10, the apparatus 1000 may comprise a receiving unit 1001 and a reporting unit 1002. In an exemplary embodiment, the apparatus 1000 may be implemented in a policy charging node such as the PCF shown in FIG. 3. The receiving unit 1001 may be operable to carry out the operation in block 602, and the reporting unit 1002 may be operable to carry out the operation in block 604. Optionally, the receiving unit 1001 and/or the reporting unit 1002 may be operable to carry out more or less operations to implement the proposed methods according to the exemplary embodiments of the present disclosure.

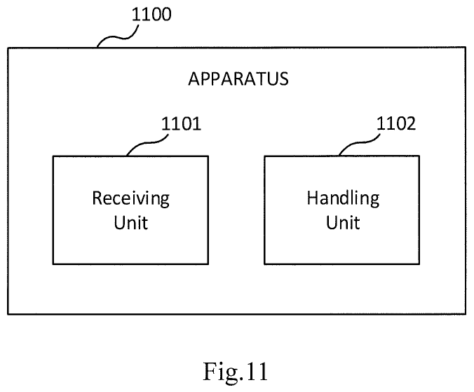

FIG. 11 is a block diagram illustrating an apparatus 1100 according to some embodiments of the present disclosure. As shown in FIG. 11, the apparatus 1100 may comprise a receiving unit 1101 and a handling unit 1102. In an exemplary embodiment, the apparatus 1100 may be implemented in a call control node such as the P-CSCF shown in FIG. 3 and FIG. 4. The receiving unit 1101 may be operable to carry out the operation in block 702, and the handling unit 1102 may be operable to carry out the operation in block 704. Optionally, the receiving unit 1101 and/or the handling unit 1102 may be operable to carry out more or less operations to implement the proposed methods according to the exemplary embodiments of the present disclosure.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1-24. (canceled)

25. A method performed by a session management node, comprising:
receiving an evolved packet system, EPS, fallback indicator from a mobility management node; and
reporting an EPS fallback event to a policy charging entity, according to the EPS fallback indicator, wherein the EPS fallback indicator indicates that a fallback to an EPS for an Internet protocol multimedia subsystem, IMS, voice service is ongoing.

26. The method according to claim 25, wherein the EPS fallback event is reported to the policy charging entity, in response to a subscription of the EPS fallback event by the policy charging entity.

27. The method according to claim 26, wherein the subscription of the EPS fallback event by the policy charging entity is informed to the session management node in a first notification from the policy charging entity.

28. The method according to claim 25, wherein the EPS fallback event is reported to the policy charging entity in a second notification from the session management node.

29. A method performed by a policy charging entity, comprising:
receiving an evolved packet system, EPS, fallback event report from a session management node; and
reporting:
an EPS fallback event to a call control node, according to the EPS fallback event report.

30. The method according to claim 29, wherein the EPS fallback event is reported to the call control node, in response to a subscription of the EPS fallback event by the call control node.

31. The method according to claim 30, wherein the subscription of the EPS fallback event by the call control node is informed to the policy charging entity in an authentication and authorization request from the call control node.

32. The method according to claim 29, wherein the EPS fallback event is reported to the call control node in a re-authentication request from the policy charging entity.

33. A method performed by a call control node, comprising:
receiving an evolved packet system, EPS, fallback event report from a policy charging entity; and
handling signaling based at least in part on the EPS fallback event report.

34. The method according to claim 33, wherein the EPS fallback event report is received from the policy charging entity, in response to a subscription of an EPS fallback event by the call control node.

35. The method according to claim 34, wherein the subscription of the EPS fallback event by the call control node is informed to the policy charging entity in an authentication and authorization request from the call control node.

36. The method according to claim 33, wherein the EPS fallback event report is received in a re-authentication request from the policy charging entity.

37. The method according to claim 33, wherein the handling of the signaling comprises at least one of:
buffering call setup signaling;
prolonging transmission time of call setup signaling; and
holding one or more session initiation protocol signals.

38. The method according to claim 33, further comprising:
resuming a call setup in response to an access type change event.

39. The method according to claim 38, wherein the access type change event comprises at least one of:
a radio access technology type change event; and
an internet protocol connectivity access network change event.

40. A session management node, comprising:
one or more processors; and
one or more memories storing computer program codes,
the one or more memories and the computer program codes configured to, with the one or more processors, cause the session management node at least to:
receive an evolved packet system, EPS, fallback indicator from a mobility management node; and
report an EPS fallback event to a policy charging entity, according to the EPS fallback indicator, wherein the EPS fallback indicator indicates that a fallback to an EPS for an Internet protocol multimedia subsystem, IMS, voice service is ongoing.

41. The session management node according to claim 40, wherein the EPS fallback event is reported to the policy charging entity, in response to a subscription of the EPS fallback event by the policy charging entity.

42. The session management node according to claim 41, wherein the subscription of the EPS fallback event by the policy charging entity is informed to the session management node in a first notification from the policy charging entity.

43. The session management node according to claim 40, wherein the EPS fallback event is reported to the policy charging entity in a second notification from the session management node.

44. A policy charging entity, comprising:
one or more processors; and
one or more memories storing computer program codes,
the one or more memories and the computer program codes configured to, with the one or more processors, cause the policy charging entity at least to:
receive an evolved packet system, EPS, fallback event report from a session management node; and
report an EPS fallback event to a call control node, according to the EPS fallback event report.

45. A call control node, comprising:
one or more processors; and
one or more memories storing computer program codes,
the one or more memories and the computer program codes configured to, with the one or more processors, cause the call control node at least to:
receive an evolved packet system, EPS, fallback event report from a policy charging entity; and
handle signaling based at least in part on the EPS fallback event report.
